(19) United States
(12) Patent Application Publication
(10) Pub. No.: US 2009/0018253 A1
(43) Pub. Date: Jan. 15, 2009

(54) PERFROMANCE ADDITIVES FOR THERMOPLASTIC ELASTOMERS

(75) Inventor: Johnson Thomas, Kingsport, TN (US)

Correspondence Address: TAMMYE TAYLOR, EASTMAN CHEMICAL COMPANY, 100 N. EASTMAN RD., KINGSPORT, TN, 37660-5075, US

(73) Assignee: EASTMAN CHEMICAL COMPANY, Kingsport, TN (US)

(21) Appl. No.: 12/169,235

(22) Filed: Jul. 8, 2008

Related U.S. Application Data
(60) Provisional application No. 60/958,840, filed on Jul. 9, 2007.
(60) Provisional application No. 60/968,387, filed on Aug. 28, 2007.

(51) Int. Cl. C08L 53/00; C08L 53/02

(52) U.S. Cl. 524/505; 525/95; 525/98; 525/97

(57) ABSTRACT

Thermoplastic elastomer compositions with improved elastic properties, mechanical properties, and processability are disclosed. The compositions include thermoplastic elastomers and performance additives selected from aliphathic, aromatic, or aliphatic-aromatic resins having a number-average molecular weight of 500 to 5,000.

### CROSS-REFERENCE TO RELATED APPLICATIONS

This application claims the benefit of the filing dates of Provisional Application No. 60/958,840, filed on Jul. 9, 2007, and Provisional Application No. 60/968,387, filed on Aug. 28, 2007. The entire content of both applications is hereby incorporated by reference.

### FIELD OF THE INVENTION

This invention generally relates to thermoplastic elastomer (TPE) compositions with improved properties such as elastic properties, mechanical properties, and processability. The invention pertains, more particularly, to TPE compositions containing performance additives, which can lower the compression set while maintaining the mechanical properties of the compositions.

### BACKGROUND OF THE INVENTION

Thermoplastic elastomers (TPEs) are a new class of materials obtained by blending elastomers and plastics. The combination provides these materials with a unique combination of elastic properties, mechanical properties, and processability. The use-temperatures of these materials can range from very low temperatures, approaching the glass transition temperature of the elastomeric phase, to high temperatures, approaching the melting or softening point of the plastic component. At the processing temperature, they are in the melt phase and can be processed with plastic processing equipment. The elastomeric phase provides the necessary elastic properties such as compression set, stress relaxation, elongation, and tension set. Mechanical properties like tensile and tear strength are more dependent on the plastic phase. Often, the industry is challenged to optimize these properties without negatively affecting other properties.

There have been studies of blends of polypropylene with styrenic block copolymers. These studies highlight the challenge of balancing the different properties of these systems. In many cases where better elastic properties are sought with higher mechanical properties, one has to select an elastomer with high elastic properties like ethylene-propylene-diene rubber (EPDM), silicones, or fluoropolymers. Another approach to address these performance issues is to vulcanize the rubber phase within the TPE. In either case, however, the softness obtained by using styrenic block copolymers is lost.

Accordingly, there remains a need in the art to improve the elastic properties and mechanical properties of TPEs. The present invention addresses this as well as other needs that may become apparent to those skilled in the art upon reading the following description by adding certain performance additives to TPE compositions to control the morphology of the different phases in the TPEs to maximize their performance.

### SUMMARY OF THE INVENTION

A thermoplastic elastomer composition comprising a thermoplastic elastomer and a performance additive selected from an aliphathic, an aromatic, or an aliphatic-aromatic resin having a number-average molecular weight of 500 to 5,000.

### BRIEF DESCRIPTION OF THE DRAWINGS

FIGS. 1-6 show the tensile strength, Shore A hardness, ultimate elongation, tear strength, compression set, and apparent viscosity of TPE samples prepared in Control 1 and Examples 1-4.

FIGS. 7-11 show the tensile strength, ultimate elongation, Shore A hardness, compression set, and apparent viscosity of TPE samples prepared in Control 1 and Examples 5-8.

FIGS. 12-15 show the tensile strength, tear strength, ultimate elongation, and compression set of TPE samples prepared in Control 2 and Examples 9-14.

FIG. 16 shows the tensile strength of TPE samples prepared in Controls 3-4 and Examples 15-16.

### DETAILED DESCRIPTION OF THE INVENTION

Before the present compositions of matter and methods are disclosed and described in more detail, it is to be understood that this invention is not limited to specific synthetic methods or to particular formulations, except as indicated, and as such, may vary from the disclosure. It is also to be understood that the terminology used is for the purpose of describing particular embodiments only, and is not intended to limit the scope of the invention.

The articles “a,” “an,” and “the” mean one or more, unless the context clearly indicates otherwise. Similarly, plural nouns also mean one or more, unless the context clearly indicates otherwise.

“Optional” or “optionally” means that the subsequently described events or circumstances may or may not occur. The description includes instances where the events or circumstances occur, and instances where they do not occur.

Ranges may be expressed herein as from about one particular value, and/or to about another particular value. When such a range is expressed, it is to be understood that another embodiment is from the one particular value and/or to the other particular value, along with all combinations within the range.

Throughout this application, where patents or publications are referenced, the entire disclosure of these documents are intended to be incorporated by reference into this application, unless the context indicates otherwise, in order to more fully describe the state of the art to which the invention pertains.

One of the major challenges in thermoplastic elastomer (TPE) compositions is to obtain better elastic properties without sacrificing mechanical properties. Elastic properties usually come from the elastomeric phase of the TPE. On the other hand, the plastic phase in the TPE is the major contributing factor for obtaining better mechanical properties. The ratio of rubber and plastic in TPE has been controlled to balance these properties. It is a challenge to the industry to improve one of these properties with out losing the other.

It has been surprisingly discovered that performance additives with aromatic, aliphatic, or both aromatic and aliphatic (mixed) characteristics can be used to modify the phase morphology of TPEs to improve both elastic properties (e.g., compression set, stress relaxation, tension set) and mechanical properties at the same time.

Any thermoplastic elastomer may be used in the present invention. For example, suitable thermoplastic elastomers include, but are not limited to, styrenic block copolymers like styrene-ethylene-butylene-styrene (SEBS), styrene-butadiene-styrene (SBS), styrene-isoprene-styrene (SIS), and styrene-ethylene-propylene-styrene (SEPS); and its blends with polyolefins (e.g., polypropylene (PP), polyethylene (PE), or other olefinic copolymers), ethylene propylene dienemonomer (EPDM) rubber, and blends of polyolefins and EPDM rubber.

For example, styrenic block copolymers (SBC) such as Kraton® (commercially available from Kraton Polymers) and Dynaflex® (commercially available from GLS Corporation) may be used as thermoplastic elastomers in the present invention. The suitable SBCs include, for example, styrene-butadiene-styrene (SBS), styrene-isoprene-styrene (SIS), styrene-ethylene-butylene-styrene (SEBS), and styrene-ethylene-propylene-styrene (SEPS).

In addition, thermoplastic vulcanizates (TPV) such as Santoprene® (commercially available from Exxon Mobil); copolyester elastomers (COPE or PCCE) such as Neostar® and Ecdel® (commercially available from Eastman Chemical); and polyolefin elastomers (POE) such as Engage® (commercially available from Dow Chemical) may be used as thermoplastic elastomers in the present invention.

The thermoplastic elastomer composition may include any of the thermoplastic elastomers singly or a blend of one or more of the thermoplastic elastomers may be used.

The performance additives that are used in the present invention include aromatic, aliphatic, and mixed aliphatic-aromatic resins. The molecular weight of these resins can range from a number-average molecular weight of 500 to 5,000.

Examples of suitable aromatic additives include resins with commercial names Endex, Kristalex, Picco, and Piccolastic. These resins can be obtained by polymerizing styrene, substituted styrenes, and indenes at different ratios and molecular weights.

Examples of suitable aliphatic additives include resins with commercial names such as Piccotac, Regalrez, Regalite, and Eastotac. Piccotacs are isoprene-based systems with a number-average molecular weight of 300 to 2000. Regalrez, Regalite, and Eastotac are hydrogenated aromatic resins or cycloaliphatic systems, depending on their model number.

Mixed resin additives are combinations of aromatic and aliphatic, and are also generally known under the commercial names, Regalite, Regalrez, Piccotac, and Eastotac, depending on their model number.

In some embodiments, suitable resins include, but are not limited to, (1) polyterpene resins and hydrogenated polyterpene resins; (2) aliphatic petroleum hydrocarbon resins and the hydrogenated derivatives thereof; (3) aromatic hydrocarbon resins and the hydrogenated derivatives thereof; and (4) alicyclic petroleum hydrocarbon resins and the hydrogenated derivatives thereof. Mixtures of two or more of the above-described resins may be used in some embodiments.

In some embodiments, suitable hydrocarbon resins include aliphatic or aromatic hydrocarbon resins, dicyclopentadiene (DCPD) resins, terpene resins, and terpene/DCPD resins.

Aliphatic resins according to the present invention are produced from at least one monomer selected from alkanes, alkenes, and alkynes. These monomers can be straight chains or branched. For example, an aliphatic resin can be produced by polymerizing cis- or trans-piperylene, isoprene, or dicyclopentadiene. Examples of aliphatic resins include, but are not limited to, Piccotac® 1095 from Eastman Chemical; Hikorez® C-110 available from Kolon Industries; and Wingtack® 95 available from Goodyear Chemical. Hydrogenated cycloaliphatic resins include, but are not limited to, Eastotac® H-100, Eastotac® H-115, Eastotac® H-130, and Eastotac® H-142 available from Eastman Chemical. The Eastotac® resins are available in various grades (E, R, L and W) that differ in the level of hydrogenation.

By further example, hydrocarbon resins such as Eastotac® (commercially available from Eastman Chemical), rosin and rosin derivative resins such as Permalyn® and Poly-Pale® (commercially available from Eastman Chemical), low molecular weight resins such as Kristalex® and Regalrez® (commercially available from Eastman Chemical), ethylene-acrylate copolymers such as EMAC and EBAC (commercially available from Westlake), ethylene-vinyl acetate copolymers such as Elvax® (commercially available from DuPont), and copolyester elastomers such as Neostar® and Ecdel® (commercially available from Eastman Chemical) may be used.

Aromatic resins according to the present invention can be produced from at least one unsaturated cyclic hydrocarbon monomer having one or more rings. For example, aromatic hydrocarbon resins can be produced from polymerizing indene, methylindene, styrene, or methylstyrene themselves or in different combinations in the presence of a Lewis acid. Commercial examples of aromatic hydrocarbon resins include, but are not limited to, Kristalex® 3100 and Kristalex® 5140 available from Eastman Chemical. Hydrogenated aromatic resins include, but are not limited to, Regalrez® 1094 and Regalrez® 1128 available from Eastman Chemical.

Aliphatic-aromatic resins according to the present invention can be produced from at least one aliphatic monomer and at least one aromatic monomer. Suitable aliphatic monomers and aromatic monomers include those discussed herein. Examples of aliphatic-aromatic resins include, but are not limited to, Piccotac® 9095 available from Eastman Chemical and Wingtack® Extra available from Goodyear Chemical. Hydrogenated aliphatic-aromatic resins include, but are not limited to, Regalite® V3100 available from Eastman Chemical and Escorez® 5600 available from Exxon Mobil Chemical.

Polyterpene resins according to the present invention are resins produced from at least one terpene monomer. For example, α-pinene, β-pinene, d-limonene, and dipentene can be polymerized in the presence of aluminum chloride to provide polyterpene resins. Other examples of polyterpene resins include, but are not limited to, Sylvares® TR 1100 available from Arizona Chemical and Piccolyte® A125 available from Pinova.

Examples of aromatically modified terpene resins include, but are not limited to, Sylvares® ZT 105LT and Sylvares® ZT 115LT available from Arizona Chemical.

In one embodiment, the thermoplastic elastomer composition comprises low molecular weight styrenic block copolymers (SBC). In these embodiments, the compositions are melt processable and show improved elastic and mechanical properties. The performance additives can drastically improve the mechanical properties of the compositions while maintaining or even improving their processability.

Typically, high molecular weight styrenic block copolymers are not easily processable because the high molecular weight polymers (typically, with molecular weights greater than 100,000) alone do not flow well under normal plastic processing conditions, for example, at 180-230° C. This is due to the phase incompatibility that necessitates high temperature and high shear conditions to transform biphasic SBCs to a molten single phase system. For example, they may have high order-disorder temperatures, generally estimated at about 350° C. When processed at high temperatures, there may be degradation of polymer chains, which may cause a drop in mechanical properties.

On the other hand, lower molecular weight SBCs (for example, with molecular weights less than about 100,000) may be readily processed under normal plastic processing conditions, but they may not provide the level of performance that may be necessary for some applications. Without being bound by any theory, the improved performance may be caused by the toughening of the styrenic phase in the low molecular weight SBCs for aromatic additives and increased interdiffusion between the styrenic and olefin phases for mixed and aliphatic additives.

In one embodiment, the aliphatic, aromatic, or mixed performance additives according to the present invention may be added to compositions containing low molecular weight SBCs to provide improved tensile strength, tear strength and elongation at break as well as providing improved processibility. For example, in some embodiments, the improvement in performance allows low molecular weight SBCs to perform at the same or at higher levels than high molecular weight SBCs.

The thermoplastic elastomer compositions according to the present invention can have various amounts of the performance additives. Typical additive levels include 5 to 50 parts (by weight) of performance additive per 100 parts of the SBC. Preferred additive levels include 10 to 30 parts of performance additive per 100 parts of the SBC.

The thermoplastic elastomer and performance additive may be combined in any melt mixing device such as a bra bender or internal mixer.

The thermoplastic elastomer compositions may contain fillers, processing oils, stabilizers, and antioxidants.

The thermoplastic elastomer compositions of the present invention can be used in applications where unmodified TPEs have been used such as in extrusion and injection molding processes. The thermoplastic elastomer compositions of the invention can be used in various automotive, construction and household and personal care applications including, but not limited to, seals and gaskets, over molding, bottle closures and caps, weather strips, closures, kitchenware grips & food storage, plumbing gaskets, construction seals, automotive boots, dishwasher boots/seals, toothbrush/razor soft grips, hand/power tools, automotive ducting, wire and cable insulation, athletic shoe soles, and caster wheel treads.

This invention can be further illustrated by the following examples of preferred embodiments thereof, although it will be understood that these examples are included merely for purposes of illustration and are not intended to limit the scope of the invention.

### EXAMPLES

The following methodology was used to measure the mechanical properties and the melt rheology of the thermoplastic elastomer compositions.

### Mechanical Properties

Tensile strength, modulus, and elongation at break were measured as per ASTM D412 in a MTS UTM (4201) at a crosshead speed of 500 mm/min. Dumbbell-shaped specimens were cut from molded sheets. Tear strength was measured at the same conditions following ASTM D624. The results of six tests were averaged. Shore hardness was measured following ASTM D2240 using Type A durometer.

### Melt Rheology

The steady shear viscosity from 100 to 50001/sec was measured on a Rheograph 2000 (Goettfert, Inc. Rockhill, S.C.) with a capillary 0.8 mm diameter×30 mm long at 210° C. The dynamic mechanical data were measured on a Rheometrics RDAII using 25 mm diameter parallel plates with a 1 mm gap. A dynamic frequency sweep was run from 1 to 400 rad/sec of frequency with 10% strain amplitude at 210° C.

### Control 1 and Examples 1-4

### PP/SEBS with Aromatic Resin Performance Additives

Thermoplastic elastomer compositions were prepared by mixing the components in the proportions (parts by weight) listed in Table 1 below in a 30-mm co-rotating twin-screw extruder with the temperature of the different zones kept at 190° C. After extrusion, samples were injection molded for testing.

TABLE 1

| Component | Control 1 | Ex. 1 | Ex. 2 | Ex. 3 | Ex. 4 |
|---|---|---|---|---|---|
| Kraton G1651 | 100 | 100 | 100 | 100 | 100 |
| Marlex HGL 120 | 60 | 60 | 60 | 60 | 60 |
| Omyacarb 3 | 100 | 100 | 100 | 100 | 100 |
| Drakeol 34 | 200 | 200 | 200 | 200 | 200 |
| Endex 160 | 0 | 30 | 0 | 0 | 0 |
| Kristalex 5140 | 0 | 0 | 30 | 0 | 0 |
| Picco 5140 | 0 | 0 | 0 | 30 | 0 |
| Plastolyn D125 | 0 | 0 | 0 | 0 | 30 |
| Stabilizer | 1 | 1 | 1 | 1 | 1 |
| Antioxidant | 1 | 1 | 1 | 1 | 1 |

In Table 1, Kraton G1651 is an SEBS block copolymer with 30% styrene content. Marlex HGL 120 is polypropylene. Omycarb 3 is a calcium carbonate filler. Drakeol 34 is a processing oil. Endex 160, Kristalex 5140, Picco 5140, and Plastolyn D125 are different types of aromatic resin performance additives.

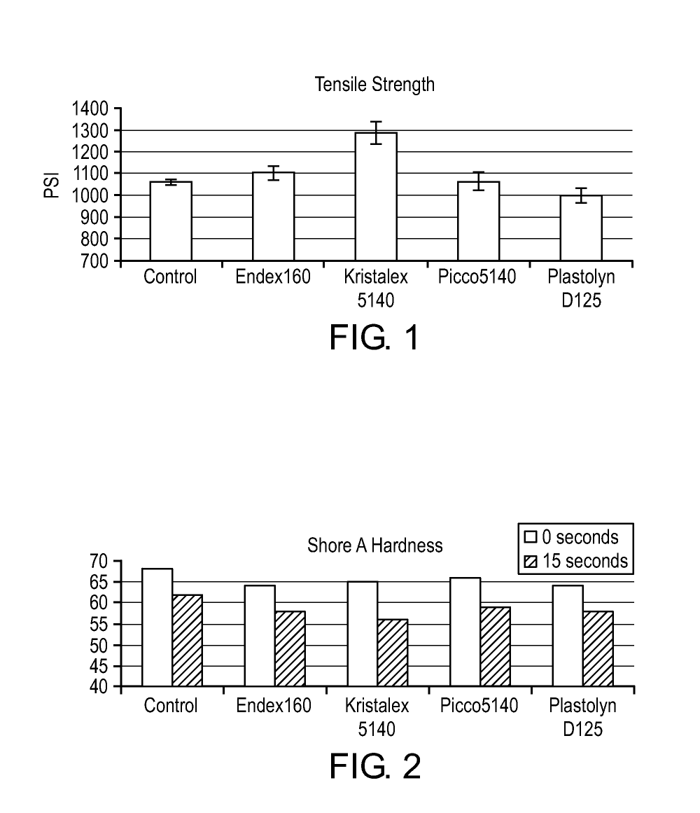

FIG. 1 shows the tensile strength of the samples. As seen from FIG. 1, most of the aromatic resin additives increased the tensile strength of the compositions compared to Control 1.

FIG. 2 shows the Shore A hardness of the samples. As seen from FIG. 2, the aromatic resin additives increased the softness of the compositions compared to Control 1.

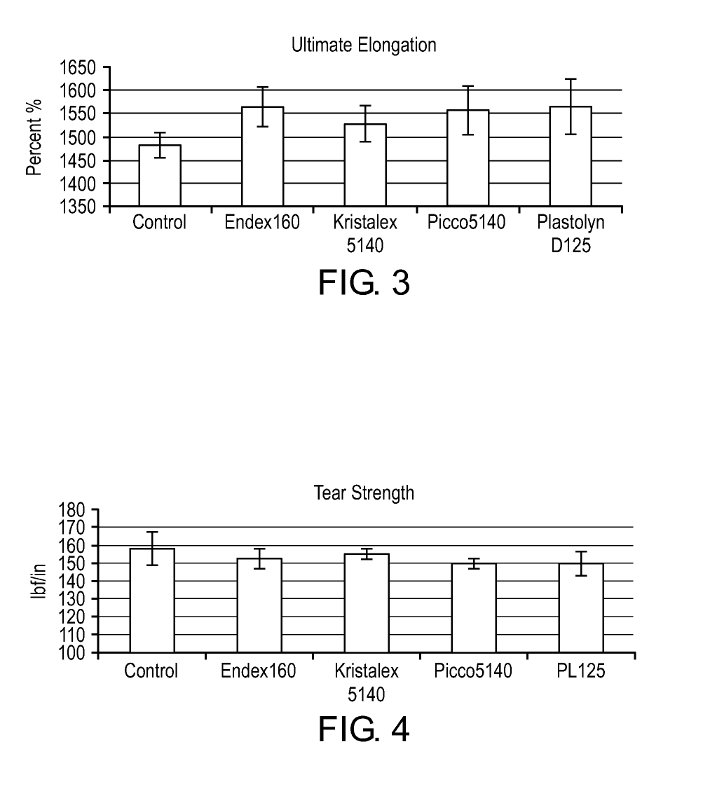

FIG. 3 shows the ultimate elongation of the samples, and FIG. 4 shows their tear strength. As seen from FIGS. 3 and 4, the aromatic resin additives improved the ultimate elongation of the compositions while maintaining their tear strength, relative to Control 1.

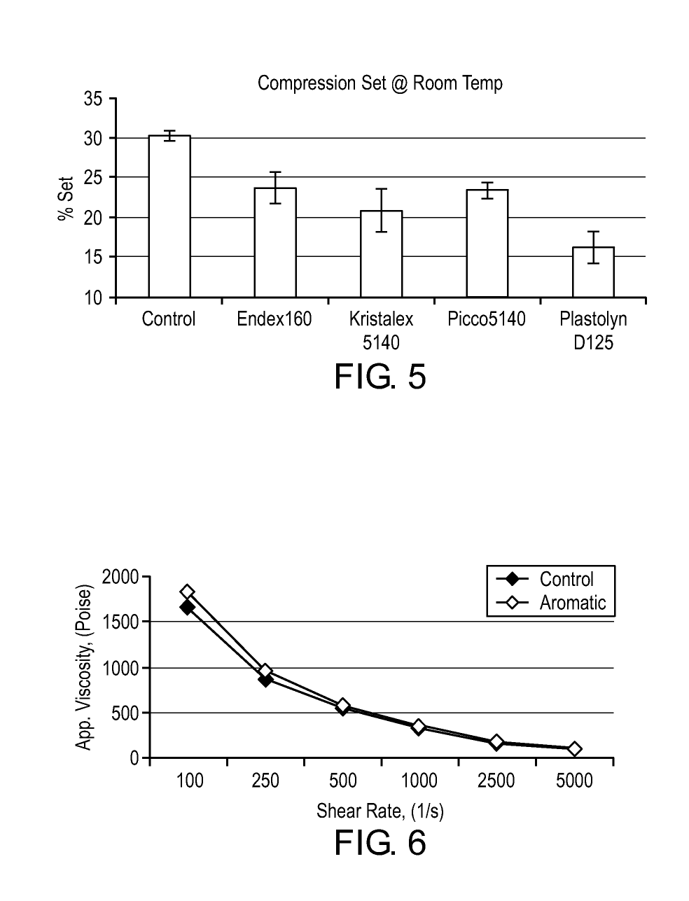

FIG. 5 shows the compression set properties of the samples. As seen from FIG. 5, the aromatic resin additives lowered the compression set properties of the compositions compared to Control 1. Lowering the compression set of polyolefin/elastomer blends without losing their mechanical properties was unexpected and highly desirable in this class of TPEs.

FIG. 6 shows the apparent viscosity of the control sample and that of Example 1 with Endex 160. As seen from FIG. 6, the apparent viscosity of the composition with the aromatic resin additive increased compared to Control 1. This behavior further helps in processing TPEs for such application as extrusion and blow molding where higher viscosity at low shear rates is desired.

### Examples 5-8

### PP/SEBS with Aliphatic Resin Performance Additives

Thermoplastic elastomer compositions were prepared following the procedures described in Examples 1-4, except that the aromatic resin additives were replaced with aliphatic resin additives. The aliphatic resin additives were Piccotac 1115 (Example 5), Regalite 1125 (Example 6), Regalrez 1126 (Example 7), and Eastotac H142W (Example 8). The aliphatic resin additives were used in the same amounts as the aromatic resin additives in Examples 1-4.

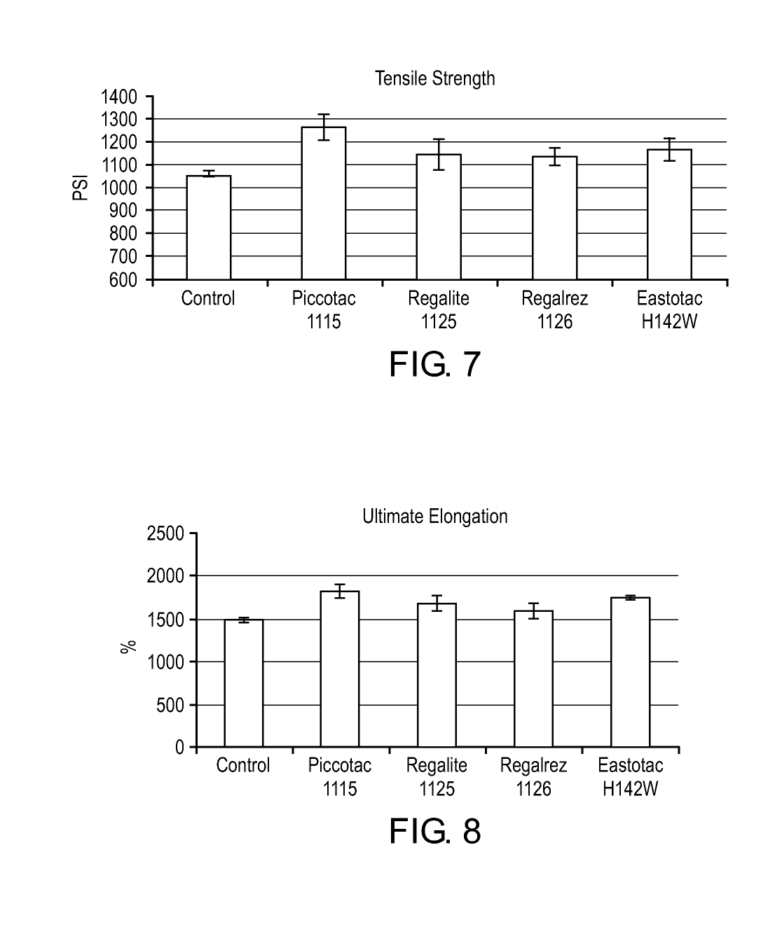

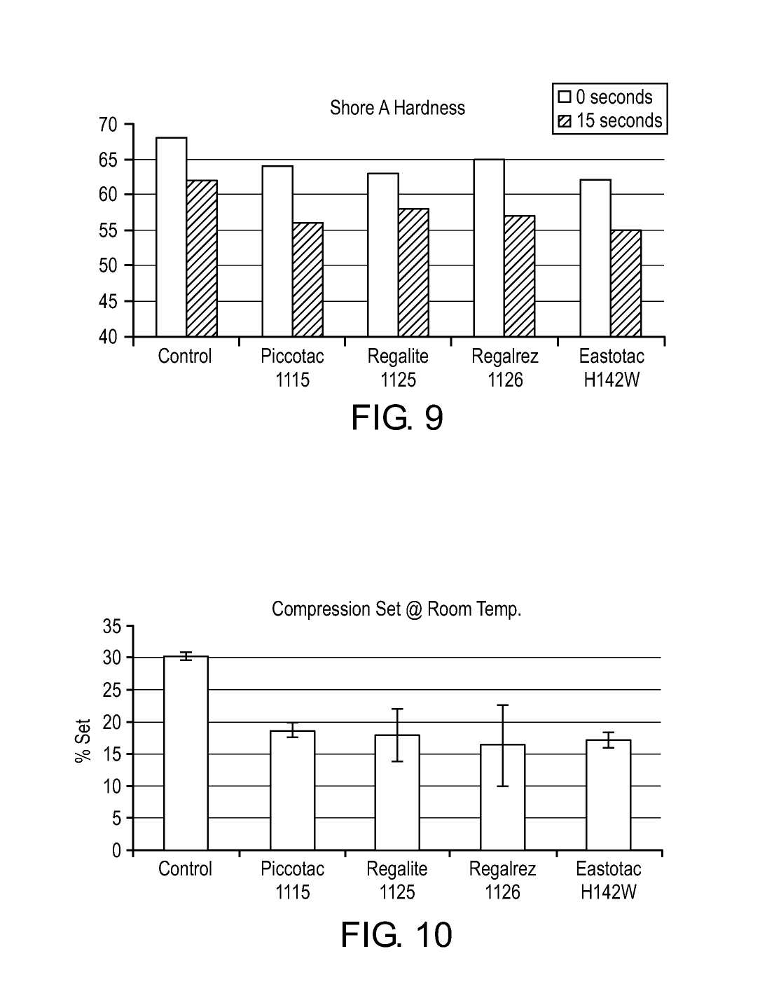

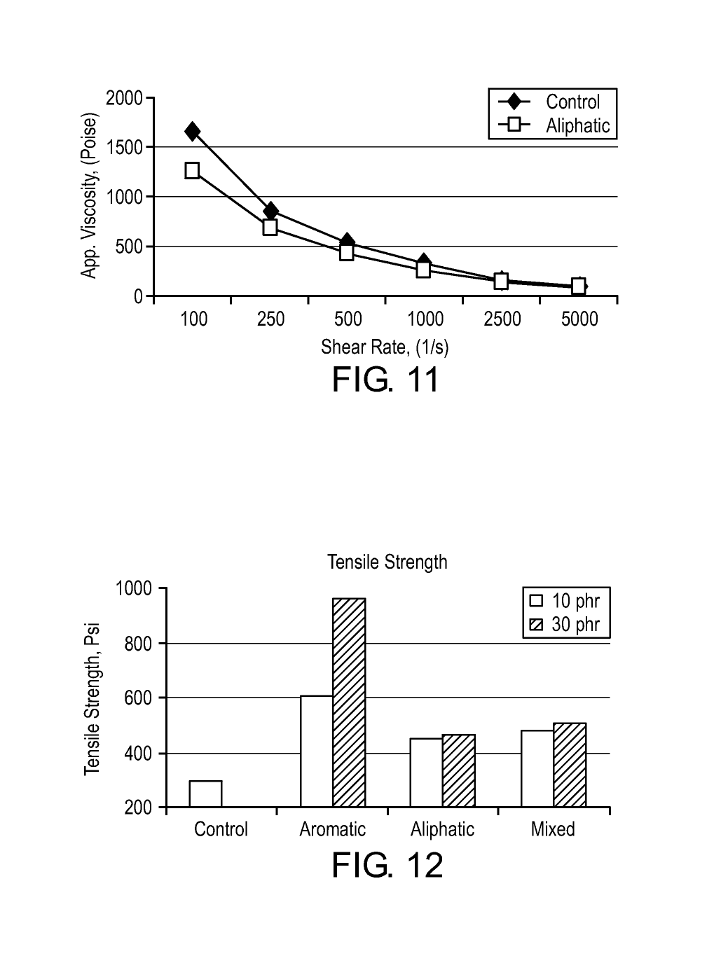

The properties of these compositions are shown in FIGS. 7-11 relative to Control 1 mentioned above. FIGS. 7 and 8 show that the aliphatic resin additives increased the tensile strength and ultimate elongation of the TPE compositions relative to Control 1. FIGS. 9 and 10 show that the aliphatic resin additives softened the TPE compositions and lowered their compression set properties relative to Control 1. Thus, the aliphatic resin additives can improve both the mechanical as well as the elastic properties of the TPE compositions.

In contrast to the aromatic resin additives, the aliphatic resin additives decreased the melt viscosity of the TPE composition relative to Control 1. This property allows for better mold flow and faster processing in a molding operation.

### Control 2 and Examples 9-14

### SEBS Alone with Aromatic, Aliphatic, and Aliphatic-Aromatic Resin Performance Additives

Thermoplastic elastomer compositions were prepared following the procedures of Control 1 and Examples 1-4, except that no polypropylene was used. The ingredients and their proportions (parts by weight) in the compositions are shown in Table 2 below.

TABLE 2

| | Control | | Ex. | Ex. | Ex. | | |
|---|---|---|---|---|---|---|---|
| Component | 2 | Ex. 9 | 10 | 11 | 12 | Ex. 13 | Ex. 14 |
| Kraton G1651 | 100 | 100 | 100 | 100 | 100 | 100 | 100 |
| Omyacarb 3 | 100 | 100 | 100 | 100 | 100 | 100 | 100 |
| Drakeol 34 | 200 | 200 | 200 | 200 | 200 | 200 | 200 |
| Kristalex 5140 | 0 | 10 | 30 | 0 | 0 | 0 | 0 |
| Regalite R1125 | 0 | 0 | 0 | 10 | 30 | 0 | 0 |
| Regalite S5100 | 0 | 0 | 0 | 0 | 0 | 10 | 30 |
| Stabilizer | 1 | 1 | 1 | 1 | 1 | 1 | 1 |
| Antioxidant | 1 | 1 | 1 | 1 | 1 | 1 | 1 |

As noted above, Kristalex 5140 is an aromatic resin, Regalite R1125 is an aliphatic resin, and Regalite S5100 is a mixed aliphatic-aromatic resin.

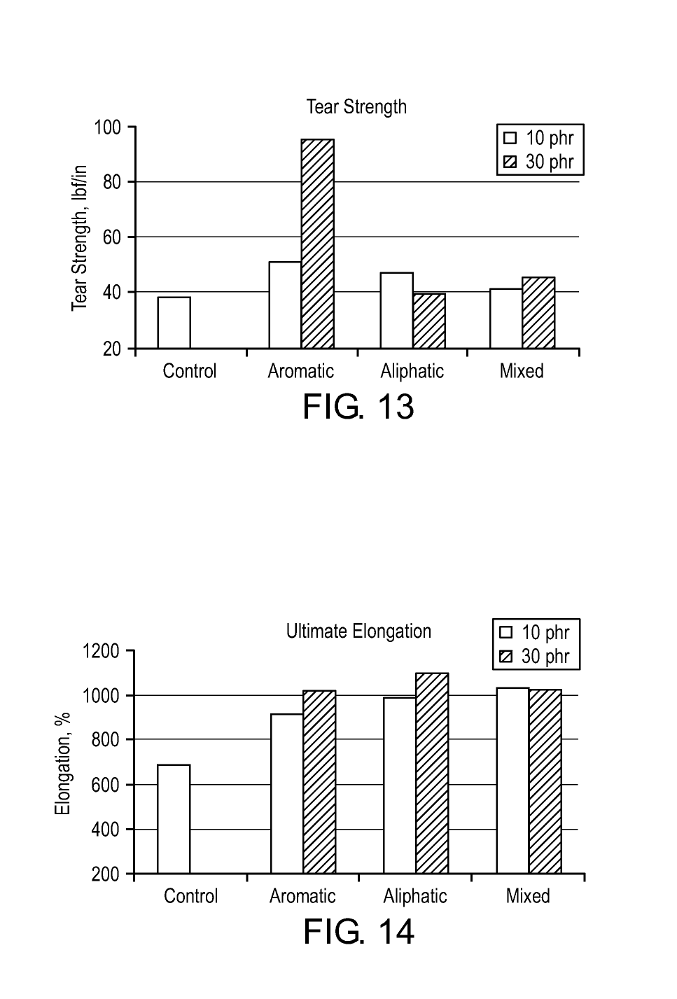

The results are shown in FIGS. 12-15. As seen in FIGS. 12-14, at both loading levels, the aromatic, aliphathic, and mixed resin additives dramatically improved the tensile strength, tear strength, and ultimate elongation of the TPE compositions in the absence of polypropylene, relative to Control 2.

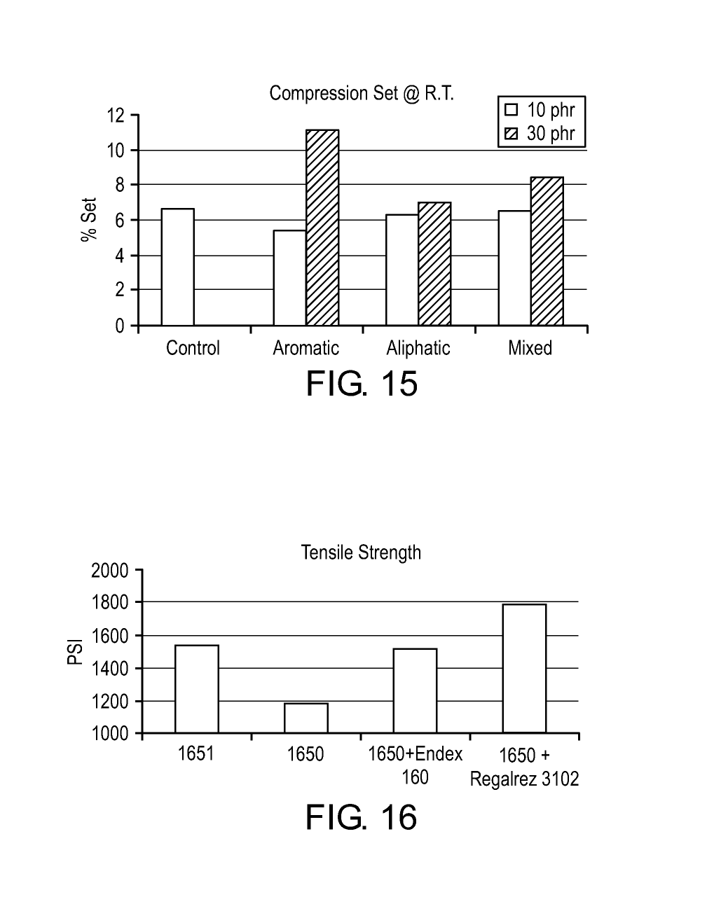

As seen in FIG. 15, at low loading levels of the aromatic resin, and at both loading levels of the aliphatic and the mixed resin additives, there was little, if any, loss in compression set properties.

Examples 1-14 show that the additives of the present invention can simultaneously improve both the elastic and the mechanical properties of styrenic block copolymers and blends of styrenic block copolymers with polyolefins.

### Controls 3-4 and Examples 15-16

### Low Molecular Weight SEBS Alone with Aromatic and Aliphatic-Aromatic Resin Performance Additives

Thermoplastic elastomer compositions were prepared following the procedures of Control 1 and Examples 1-4, except that no polypropylene was used and instead of injection molding, the samples were obtained by compression molding. The ingredients and their proportions (parts by weight) in the compositions are shown in Table 3 below.

TABLE 3

| Component | Control 3 | Control 4 | Ex. 15 | Ex. 16 |
|---|---|---|---|---|
| Kraton G1651 | 100 | 0 | 0 | 0 |
| Kraton G1650 | 0 | 100 | 100 | 100 |
| Omyacarb 3 | 100 | 100 | 100 | 100 |
| Drakeol 34 | 200 | 200 | 200 | 200 |
| Endex 160 | 0 | 0 | 30 | 0 |
| Regalrez 3102 | 0 | 0 | 0 | 30 |
| Stabilizer | 1 | 1 | 1 | 1 |
| Antioxidant | 1 | 1 | 1 | 1 |

Kraton G1651 is a high molecular weight SEBS block copolymer (MWₙ≈250,000). Kraton G1650 is a low molecular weight SEBS block copolymer (MWₙ≈100,000). Endex 160 is an aromatic resin. And Regalrez 3102 is a mixed aliphatic-aromatic resin.

The tensile strength results of these TPE compositions are shown in FIG. 16. As seen in FIG. 16, the aromatic and mixed resin additives improved the tensile strength of the low molecular weight SEBS copolymer. The tensile strength values of the blended low molecular weight SEBS compositions were about the same or higher than that of the high molecular weight SEBS alone.

The invention has been described in detail with particular reference to preferred embodiments thereof, but it will be understood that variations and modifications can be effected within the spirit and scope of the invention.

We claim:

1. A thermoplastic elastomer composition comprising:
(a) a thermoplastic elastomer; and
(b) a performance additive selected from an aliphathic, an aromatic, or an aliphatic-aromatic resin having a number-average molecular weight of 500 to 5,000.

2. The composition according to claim 1, wherein the thermoplastic elastomer comprises a styrenic block copolymer or a blend thereof with a polyolefin, ethylene-propylene diene monomer (EPDM) rubber, or both.

3. The composition according to claim 2, wherein the styrenic block copolymer is styrene-ethylene-butylene-styrene (SEBS), styrene-butadiene-styrene (SBS), styrene-isoprene-styrene (SIS), styrene-ethylene-propylene-styrene (SEPS), or combinations thereof.

4. The composition according to claim 2, wherein the polyolefin is polypropylene, polyethylene, or a copolymer thereof.

5. The composition according to claim 1, wherein the thermoplastic elastomer comprises thermoplastic vulcanizates, copolyester elastomers, polyolefin elastomers, or combinations thereof.

6. The composition according to claim 1, wherein the performance additive is an aromatic resin comprising styrene, substituted styrene, indene, or substituted indene monomer units.

7. The composition according to claim 1, wherein the performance additive is an aliphatic resin comprising ethylene, piperylene, isoprene, terpene, or dicyclopentadiene monomer units.

8. The composition according to claim 1, wherein the performance additive is an aliphatic-aromatic resin.

9. The composition according to claim 2, which comprises 5 to 50 parts of the performance additive per 100 parts of the styrenic block copolymer.

10. The composition according to claim 2, which comprises 10 to 30 parts of the performance additive per 100 parts of the styrenic block copolymer.

11. The composition according to claim 1, which further comprises fillers, processing oils, stabilizers, antioxidants, or combinations thereof.

12. The composition according to claim 1, wherein the thermoplastic elastomer has a number-average molecular weight of less than 100,000.
